(19) United States
(12) Patent Application Publication
(10) Pub. No.: US 2022/0111652 A1
(43) Pub. Date: Apr. 14, 2022

(54) LIQUID DISCHARGE APPARATUS

(71) Applicant: CANON KABUSHIKI KAISHA, Tokyo (JP)

(72) Inventors: Yuta Araki, Chiba (JP); Koya lwakura, Kanagawa (JP); Hideaki Matsumura, Kanagawa (JP); Tetsu Hamano, Tokyo (JP); Nobuhiro Toki, Kanagawa (JP); Daiju Takeda, Kanagawa (JP); Fumie Kameyama, Tokyo (JP); Koki Shimada, Kanagawa (JP); Shota Asada, Tokyo (JP); Ken Takenaga, Kanagawa (JP); Yusuke Tanaka, Kanagawa (JP); Taiji Maruyama, Kanagawa (JP); Atsushi Matsuyama, Kanagawa (JP); Yusuke Naratani, Tokyo (JP); Kousuke Tanaka, Kanagawa (JP)

(21) Appl. No.: 17/496,936

(22) Filed: Oct. 8, 2021

(30) Foreign Application Priority Data
Oct. 9, 2020 (JP) 2020-171418

(51) Int. Cl. B41J 2/165

(52) U.S. Cl. CPC B41J 2/16517

(57) ABSTRACT

A liquid discharge apparatus includes a first absorbent member extending in a discharge region to which a discharge unit capable of discharging a liquid onto a medium discharges liquid, and configured to be capable of accepting the liquid discharged from the discharge unit, a second absorbent member arranged spaced apart from the first absorbent member to accept liquid flowed out from the first absorbent member when the liquid discharge apparatus is inclined from a posture for use of the liquid discharge to a predetermined direction, and a positioning portion configured to position the second absorbent member at a position spaced apart from the first absorbent member.

### BACKGROUND OF THE INVENTION

### Field of the Invention

The present invention relates to a liquid discharge apparatus.

### Description of the Related Art

An inkjet printing apparatus that performs printing without margins in the edge portions of a sheet (to be referred to as “marginless printing” hereinafter) is provided with an absorbent member for accepting ink discharged to the outside of the sheet (Japanese Patent Laid-Open No. 2013-39799). Since the ink is absorbed by the absorbent member, it can be prevented that the sheet is contaminated with the ink in the subsequent printing.

In a state in which a large amount of ink is absorbed in the absorbent member, if the inkjet printing apparatus is set in an inclined posture for transportation, the ink may overflow from the absorbent member and contaminate the surrounding area.

### SUMMARY OF THE INVENTION

The present invention provides a technique of, when the posture of an apparatus is inclined, preventing a liquid flowing out from an absorbent member from contaminating a surrounding area.

According to one aspect of the present invention, there is provided a liquid discharge apparatus comprising: a first absorbent member extending in a discharge region to which a discharge unit capable of discharging a liquid onto a medium discharges liquid, and configured to be capable of accepting the liquid discharged from the discharge unit; a second absorbent member arranged spaced apart from the first absorbent member to accept liquid flowed out from the first absorbent member when the liquid discharge apparatus is inclined from a posture for use of the liquid discharge to a predetermined direction; and a positioning portion configured to position the second absorbent member at a position spaced apart from the first absorbent member.

Further features of the present invention will become apparent from the following description of exemplary embodiments (with reference to the attached drawings).

### BRIEF DESCRIPTION OF THE DRAWINGS

FIG. 1 is a schematic view showing a liquid discharge apparatus according to an embodiment of the present invention;

FIG. 2 is a perspective view showing a waste liquid tank and the arrangement in the periphery thereof;

FIG. 3 is a sectional view showing a platen member and absorbent members taken along a line A-A in FIG. 1;

FIG. 4A is an enlarged view of a P portion shown in FIG. 3;

FIG. 4B is a sectional view taken along a line B-B in FIG. 3;

FIGS. 5A and 5B are views for explaining a mode of accepting a waste ink by the main absorbent member and the sub absorbent member;

FIG. 6A is a perspective view showing the periphery of a passage according to another embodiment;

FIG. 6B is a sectional view showing the periphery of the passage shown in FIG. 6A; and

FIGS. 7A and 7B are sectional views each showing the periphery of a passage according to still another embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

<First Embodiment>

<Outline of Liquid Discharge Apparatus>

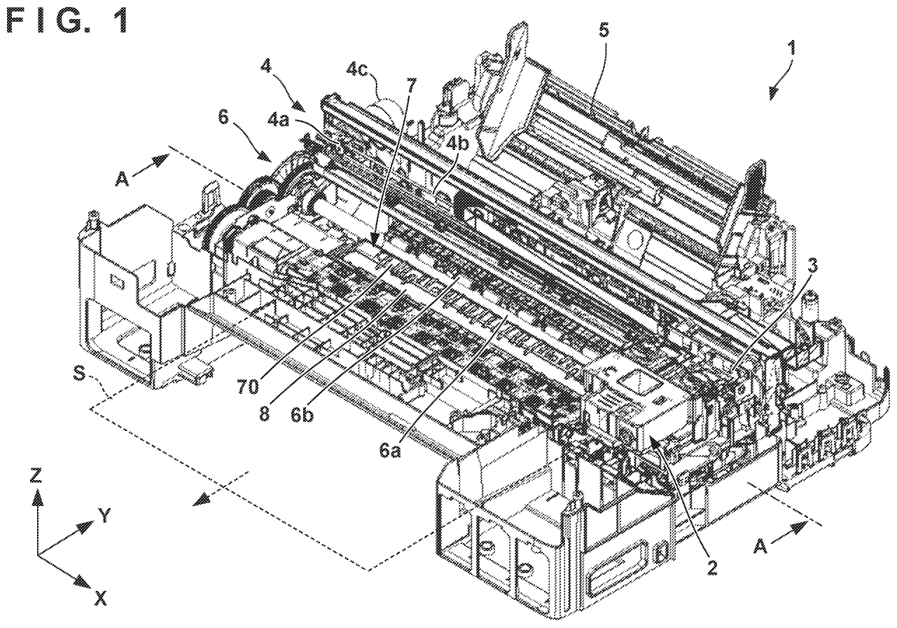

FIG. 1 is a schematic view showing a liquid discharge apparatus 1 according to an embodiment of the present invention. The liquid discharge apparatus 1 according to this embodiment is an inkjet printing apparatus that performs printing on a print medium by discharging ink as a liquid, but the present invention is also applicable to various types of liquid discharge apparatuses other than the inkjet printing apparatus. In the drawings, arrows X and Y indicate horizontal directions orthogonal to each other, and an arrow Z indicates a vertical direction (direction of gravity). The X direction is the widthwise direction (left-and-right direction) of the liquid discharge apparatus 1. The Y direction is the depth direction of the liquid discharge apparatus 1.

Note that “printing” includes not only forming significant information such as characters and graphics but also forming images, figures, patterns, and the like on print media in a broad sense, or processing print media, regardless of whether the information formed is significant or insignificant or whether the information formed is visualized so that a human can visually perceive it. In addition, although in this embodiment, sheet-like paper is assumed as a “print medium”, cloth, a plastic film, and the like may be used as print media.

The liquid discharge apparatus 1 includes a printhead 2 that can discharge ink. The printhead 2 discharges ink onto a sheet S, thereby printing an image on the sheet S. The printhead 2 includes an ink discharge surface formed with a plurality of nozzles which discharge ink, and the ink discharge surface faces a platen 70 that supports the sheet S. The platen 70 is formed by a platen member 7. Each nozzle is provided with, for example, an electrothermal transducer (heater). The electrothermal transducer bubbles ink by energizing and heating it, and discharges the ink by the bubbling energy. The printhead 2 can discharge different kinds of inks (for example, a pigment ink, a dye ink, and inks of different colors). The ink is supplied to the printhead 2 from an ink tank (not shown). Note that the printhead 2 using a piezoelectric device can also be employed. Further, the printhead 2 may be a head cartridge integrated with an ink tank storing the ink. Furthermore, the printhead 2 may be a line head in which discharge ports are arranged in a region corresponding to the width of the sheet S.

The printhead 2 is mounted on a carriage 3. The carriage 3 is reciprocated in the X direction (main scanning direction) by a driving unit 4. The driving unit 4 includes pulleys 4a arranged spacing apart from each other in the X direction (only one pulley 4a is shown in FIG. 1), an endless belt 4b wounded between the pulleys 4a, and a carriage motor 4c serving as a driving source for rotating the pulleys 4a. The carriage 3 is connected to the endless belt 4b and moves in the X direction along with traveling of the endless belt 4b. By discharging the ink from the printhead 2 onto the sheet S supported by the platen 70 in the process of movement of the carriage 3, an image is printed. This operation is referred to as a print scan.

A conveying unit 6 is a mechanism that conveys, in the Y direction (sub-scanning direction), the sheet S fed from a feeding unit 5. The feeding unit 5 includes a tray on which the sheet S is stacked, and a feeding mechanism for the sheet S. The conveying unit 6 includes a conveying roller 6a, a pinch roller 6b pressed against the conveying roller 6a, and a conveying motor (not shown) serving as a driving source for rotating the conveying roller 6a. The sheet S is nipped in a nip portion between the conveying roller 6a and the pinch roller 6b, and conveyed in the direction indicated by a dashed arrow by rotation of the conveying roller 6a. The conveying unit 6 intermittently conveys the sheet S such that the sheet S passes between the platen 70 and the printhead 2. By alternately repeating the conveying operation of the sheet S by the conveying unit 6 and a print scan, an image for each page can be printed on the sheet S.

The printhead 2 sometimes discharges the ink to the outside of the sheet S to maintain its discharge performance or perform marginless printing. The platen member 7 is provided with a main absorbent member 8 for accepting the ink discharged to the outside of the sheet S. The main absorbent member 8 is supported by the platen member 7 at a position facing the discharge surface of the printhead 2, and extends in the X direction. The ink absorbed by the main absorbent member 8 becomes a waste liquid (waste ink).

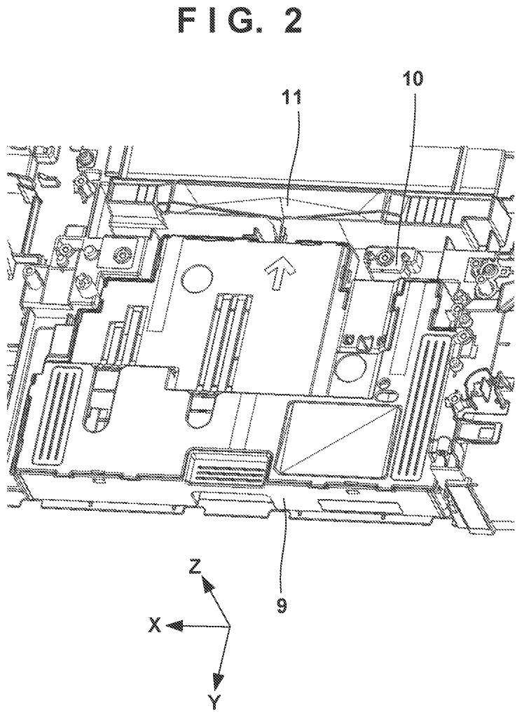

A waste liquid tank 9 for storing the waste liquid is provided in the back portion of the liquid discharge apparatus 1. FIG. 2 is a perspective view showing the periphery of the waste liquid tank 9 in the back portion of the liquid discharge apparatus 1. In this embodiment, the waste liquid tank 9 is detachably provided in a mounting portion 10. The mounting portion 10 is provided with a flow passage member 11 which collects the waste liquid and flows it into the waste liquid tank 9. If the main absorbent member 8 is filled with the waste liquid and its maximum holding amount is exceeded, the waste liquid overflows from the main absorbent member 8 and flows into the flow passage member 11. Then, the waste liquid is stored in the waste liquid tank 9.

<Structure around Platen Member>

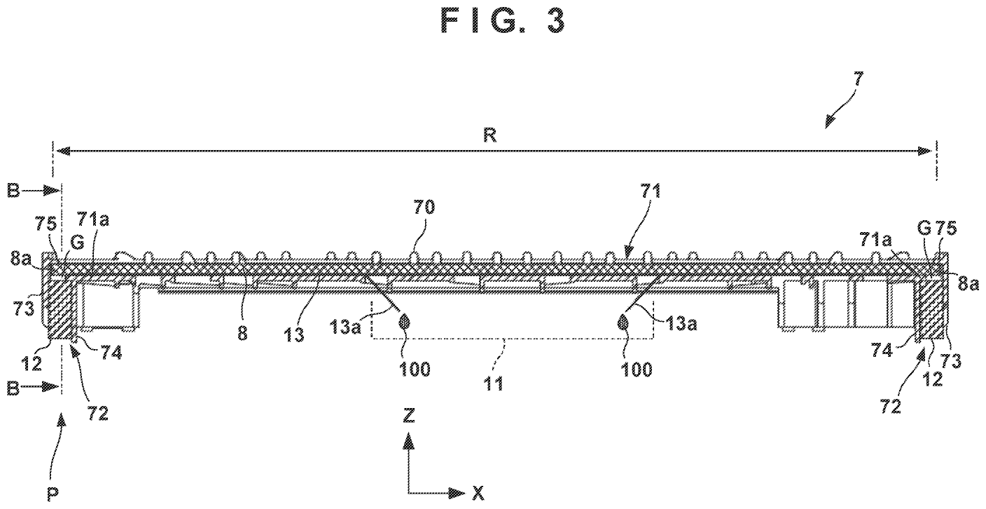

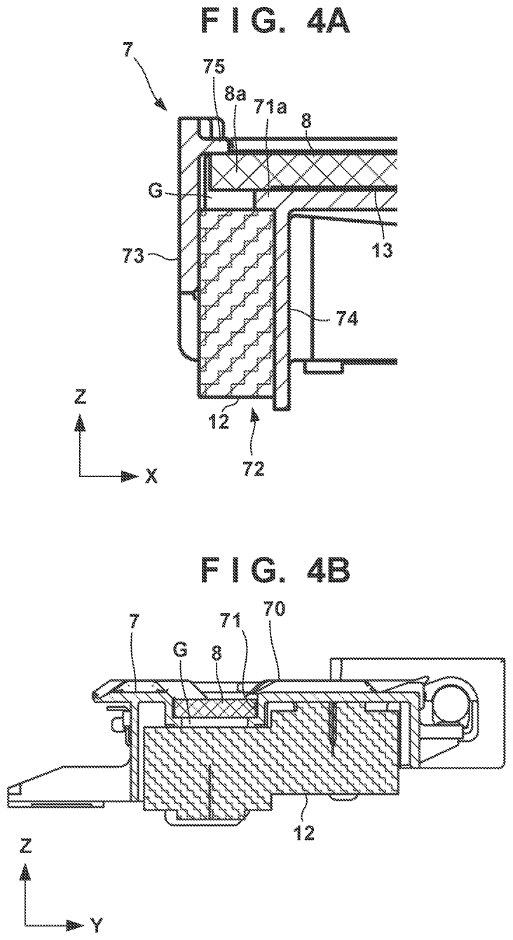

FIG. 3 is a sectional view showing the platen member 7 and the main absorbent member 8 and sub absorbent members 12 supported by the platen member 7 taken along a line A-A in FIG. 1. FIG. 4A is an enlarged view of the P portion shown in FIG. 3, and FIG. 4B is a sectional view taken along a line B-B in FIG. 3.

The platen member 7 extends in the X direction. The platen 70 includes two rows of protrusions in the Y direction, each row including a plurality of the protrusions arrayed in the X direction. A recess portion 71 extending in the X direction is formed between the two rows of the protrusions. The main absorbent member 8 is supported in the recess portion 71. The main absorbent member 8 is a band-shaped member and formed of, for example, urethane or felt. The main absorbent member 8 extends over a discharge region (image printing region) R of the printhead 2, and is arranged so as to be capable of accepting the ink discharged at an arbitrary position of the printhead 2 in the X direction.

Abridge sheet 13 is stacked on the lower surface of the main absorbent member 8. The bridge sheet 13 is a promoting member that promotes diffusion of the waste ink (transmission of the waste ink) in the main absorbent member 8 in the X and Y directions. The bridge sheet 13 is formed of, or example, pulp or felt. When the waste ink permeates the main absorbent member 8 downward in the Z direction, it reaches the bridge sheet 13 where it spreads and diffuses in the X direction or the Y direction. The waste ink is also absorbed in the bridge sheet 13.

The bridge sheet 13 includes portions 13a each diagonally hanging down toward the flow passage member 11. With this arrangement, if the maximum waste ink holding amount of the main absorbent member 8 or the bridge sheet 13 is exceeded, the waste ink travels along the portion 13a and flows out to the flow passage member 11 as schematically shown as a droplet 100 of the waste ink in FIG. 3. Therefore, overflow of the waste ink from the main absorbent member 8 is suppressed.

A support portion 72 which supports the sub absorbent member 12 is formed in each X-direction end portion of the platen member 7. Each support portion 72 includes wall portions 73 and 74 spaced apart from each other in the X direction, and the sub absorbent member 12 is supported between the wall portion 73 and the wall portion 74. The sub absorbent member 12 is formed of, for example, pulp or felt.

During use, the liquid discharge apparatus 1 is installed such that the platen member 7 is in a horizontal posture. However, during transportation or the like, the liquid discharge apparatus 1 can be set in a posture inclined to the right or left from the posture during use. If the liquid discharge apparatus 1 is set in the inclined posture while the maximum waste ink holding amount or the main absorbent member 8 of the bridge sheet 13 is exceeded, there is a possibility that the waste ink leaks from the main absorbent member 8. Particularly, when paying attention to transportation, since the liquid discharge apparatus 1 according to this embodiment is long in the X direction and short in the Y direction as a whole, an operator holds the left and right sides of the liquid discharge apparatus 1 with both hands. When the operator lifts the liquid discharge apparatus 1 or lifts it and walks, the liquid discharge apparatus 1 is likely to incline to the left or right.

The sub absorbent member 12 is arranged so as to accept the waste ink flowing out from the main absorbent member 8 when the liquid discharge apparatus 1 is set in the posture inclined to a predetermined direction as described above. In this embodiment, the sub absorbent member 12 includes a portion which is located below an X-direction end portion 8a of the main absorbent member 8 in the posture during use, and has a block shape long in the Y direction.

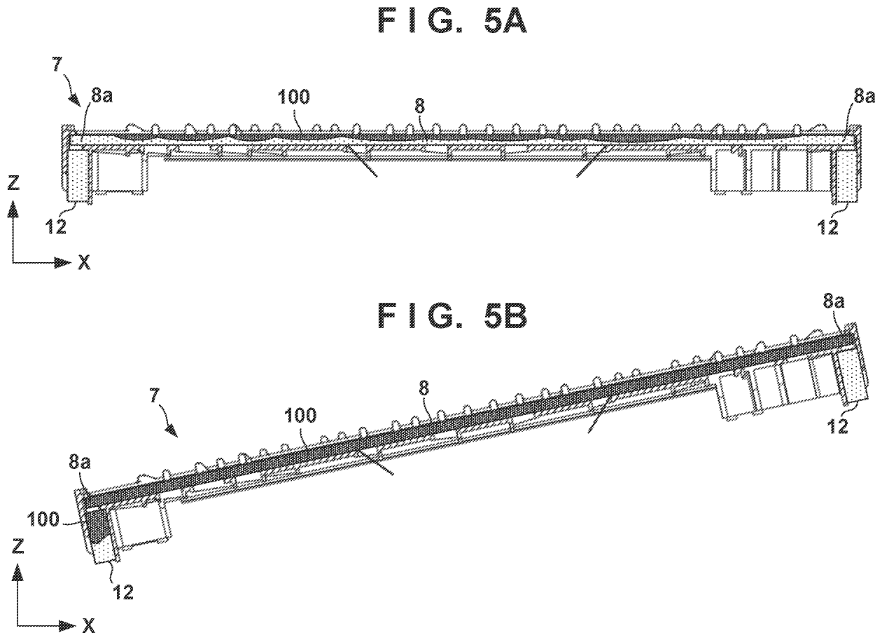

The end portion 8a is a part from which the waste ink flows out. When the liquid discharge apparatus 1 is inclined to the left or right, the waste ink flows out from the lower end portion 8a of the left and right end portions 8a of the main absorbent member 8 due to the action of gravity. Since the sub absorbent member 12 includes a portion located below the end portion 8a, the sub absorbent member 12 can accept the waste ink flowing out from the end portion 8a. FIGS. 5A and 5B are views for explaining this, each of which corresponds to a sectional view taken along the line A-A in FIG. 1.

FIG. 5A shows a mode during use. The platen member 7 is in the horizontal posture. The ink discharged from the printhead 2 is accepted by the main absorbent member 8 and absorbed as the waste ink 100 by the main absorbent member 8 over a wide range. FIG. 5B shows a mode in which the liquid discharge apparatus 1 is set in the inclined posture in which its left side is lowered. The platen member 7 is set in the inclined posture with the lift side lowered. If the excessive waste ink 100 is held in the main absorbent member 8 or the bridge sheet 13, the waste ink 100 will flow out to the left side which is lower in the direction of gravity. However, as shown in FIG. 5B, the waste ink 100 flowing out from the main absorbent member 8 or the bridge sheet 13 is accepted by the sub absorbent member 12. Thus, the waste ink 100 is prevented from leaking to the outside of the apparatus.

With reference to FIGS. 3 to 5B, the arrangement of the sub absorbent member 12 and the structure around it will be described. The sub absorbent member 12 is arranged at a position not facing the ink discharge surface of the printhead 2, where the ink discharged from the printhead 2 does not land on. Therefore, the sub absorbent member 12 does not directly accept the ink from the printhead 2. That is, the main absorbent member 8 is arranged between the ink discharge surface of the printhead 2 and the sub absorbent member 12 in the Z direction. Accordingly, the waste ink holding amount of the sub absorbent member 12 is smaller than that of the main absorbent member 8 during use of the liquid discharge apparatus 1, so that the sub absorbent member 12 has a margin to absorb the waste ink. Further, in this embodiment, the main absorbent member 8 and the sub absorbent member 12 are spaced apart from each other. Thus, during use of the liquid discharge apparatus 1, the waste ink does not flow into the sub absorbent member 12 from the main absorbent member 8. Accordingly, if the posture of the liquid discharge apparatus 1 does not change, the waste ink accepted by the main absorbent member 8 flows into the flow passage member 11, and the sub absorbent member 12 is maintained in a state of holding no waste ink.

The main absorbent member 8 and the sub absorbent member 12 communicate with each other through a passage G formed by the platen member 7. If the posture of the liquid discharge apparatus 1 has changed, the waste ink 100 overflowing from the main absorbent member 8 flows into the sub absorbent member 12 through the passage G. The bottom wall of the recess portion 71 of the platen member 7 includes a positioning portion 71a protruding above the sub absorbent member 12. The positioning portion 71a restricts displacement of the sub absorbent member 12 to the side of the main absorbent member 8. Thus, it is possible to hold the sub absorbent member 12 at a position spaced apart from the main absorbent member 8 while providing the passage G. Note that the bridge sheet 13 is spaced apart from the passage Gin the X direction.

The platen member 7 includes a cover portion 75 covering the upper surface of the end portion 8a of the main absorbent member 8. When the liquid discharge apparatus 1 is inclined to the left or right and the waste ink flows out from the lower end portion 8a of the left and right end portions 8a of the main absorbent member 8, the presence of the cover portion 75 prompts the outflow direction to the passage G. That is, the waste ink does not flow out to the side of the cover portion 75.

As has been described above, according to this embodiment, if the posture of the liquid discharge apparatus 1 is inclined, the waste ink flowing out from the main absorbent member 8 is absorbed by the sub absorbent member 12. Thus, it is possible to prevent the waste ink from contaminating the surrounding area.

<Second Embodiment>

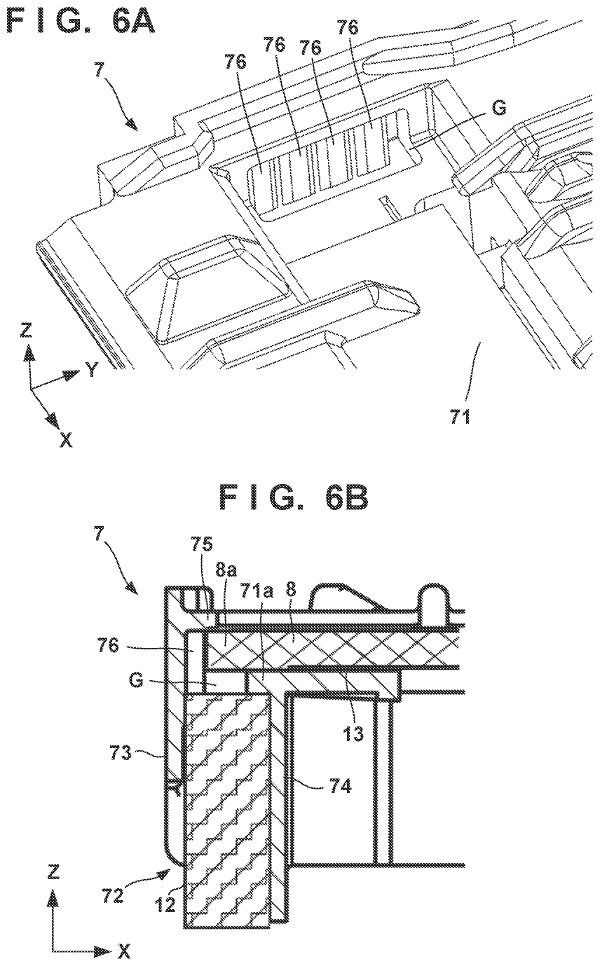

A plurality of ribs may be formed in the inner wall of a passage G in the passage widthwise direction. FIG. 6A is a perspective view of a platen member 7 showing the periphery of the passage G according to this embodiment (a main absorbent member 8 and a sub absorbent member 12 are not shown). FIG. 6B is a sectional view of the end portion of the platen member 7 according to this embodiment, and corresponds to an enlarged view of the P portion shown in FIG. 3.

In this embodiment, a plurality of ribs 76 each extending in the Z direction are formed in the passage widthwise direction (Y direction). When the posture of a liquid discharge apparatus 1 changes, a capillary force generated by gaps between the ribs 76 causes the waste ink to flow from the main absorbent member 8 to the sub absorbent member 12 more smoothly. This can further suppress leakage of the waste ink to the outside.

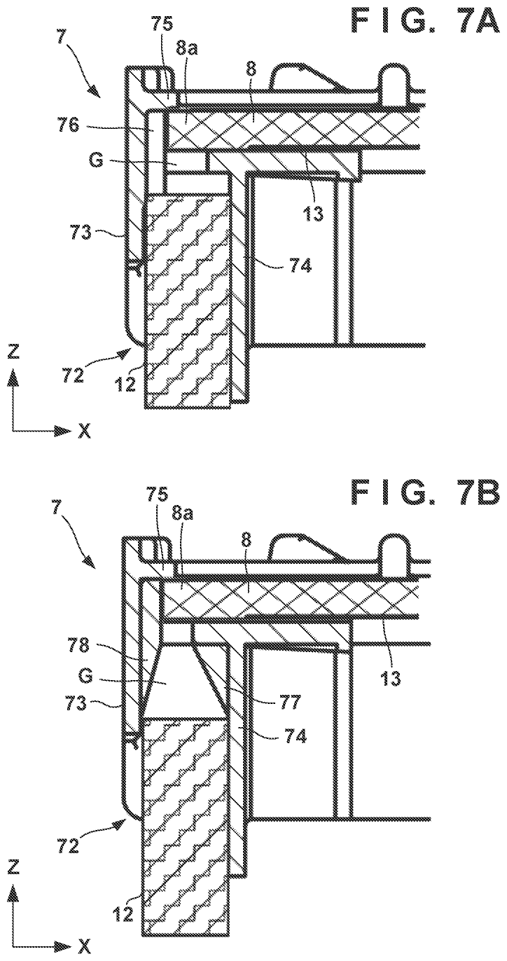

The rib 76 may serve as a positioning portion instead of the positioning portion 71a in the first embodiment. FIG. 7A shows an example of this case. In the illustrated example, the lower end face of the rib 76 abuts against the sub absorbent member 12, thereby restricting displacement of the sub absorbent member 12 to the side of the main absorbent member 8. Thus, it is possible to hold the sub absorbent member 12 at a position spaced apart from the main absorbent member 8 while providing the passage G.

<Third Embodiment>

Instead of the positioning portion 71a in the first embodiment, the shape of the passage G may be used to position the sub absorbent member 12. FIG. 7B is a sectional view of the end portion of a platen member 7 showing an example in this case, and corresponds to an enlarged view of the P portion shown in FIG. 3.

A passage G is formed to be narrower on the side of a main absorbent member 8 than on the side of a sub absorbent member 12. More specifically, the platen member 7 includes wall portions 77 and 78 spaced apart from each other in the X direction, and each of the wall portions 77 and 78 includes an inclined inner surface. The passage G is a passage that tapers from the sub absorbent member 12 toward the main absorbent member 8 in the Z direction. Since the passage G is narrow on the upper side, this restricts displacement of the sub absorbent member 12 to the side of the main absorbent member 8 (upward from the sub absorbent member 12). Thus, it is possible to hold the sub absorbent member 12 at a position spaced apart from the main absorbent member 8 while providing the passage G.

Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-171418, filed Oct. 9, 2020 which is hereby incorporated by reference herein in its entirety.

What is claimed is:

1. A liquid discharge apparatus comprising:
a first absorbent member extending in a discharge region to which a discharge unit capable of discharging a liquid onto a medium discharges liquid, and configured to be capable of accepting the liquid discharged from the discharge unit;
a second absorbent member arranged spaced apart from the first absorbent member to accept liquid flowed out from the first absorbent member when the liquid discharge apparatus is inclined from a posture for use of the liquid discharge to a predetermined direction; and
a positioning portion configured to position the second absorbent member at a position spaced apart from the first absorbent member.

2. The liquid discharge apparatus according to claim 1, further comprising
a cover portion configured to prompt an outflow of the liquid to the second absorbent member by covering a part of the first absorbent member where the liquid flows out when the liquid discharge apparatus is inclined to the predetermined direction.

3. The liquid discharge apparatus according to claim 1, wherein
the first absorbent member and the second absorbent member are spaced apart from each other via a passage of the liquid, and
the passage is narrower on a side of the first absorbent member than on a side of the second absorbent member.

4. The liquid discharge apparatus according to claim 1, wherein
the first absorbent member and the second absorbent member are spaced apart from each other via a passage of the liquid, and
a plurality of ribs are arranged in the passage in a passage widthwise direction.

5. The liquid discharge apparatus according to claim 1, further comprising
a promoting member stacked on a lower surface of the first absorbent member, and configured to promote diffusion of the liquid in the first absorbent member.

6. The liquid discharge apparatus according to claim 5, further comprising
a waste liquid tank configured to store a waste liquid of the liquid, and
the promoting member includes a portion directed to a flow passage communicating with the waste liquid tank.

7. The liquid discharge apparatus according to claim 1, further comprising the liquid discharge unit.

8. The liquid discharge apparatus according to claim 1, further comprising a platen member configured to support a sheet at a position facing the discharge unit, wherein
the first absorbent member extends in a widthwise direction of the sheet while being supported by the platen member

9. The liquid discharge apparatus according to claim 8, wherein
the platen member includes a cover portion configured to suppress an outflow of the liquid from an upper surface of the end portion of the first absorbent member by covering the upper surface.

10. The liquid discharge apparatus according to claim 8, wherein
the platen member forms a passage of the liquid between the end portion of the first absorbent member and the second absorbent member, and the passage is narrower on a side of the first absorbent member than on a side of the second absorbent member.

11. The liquid discharge apparatus according to claim 8, wherein
a passage of the liquid is formed between the end portion of the first absorbent member and the second absorbent member, and
a plurality of ribs are formed in an inner wall of the passage in a passage widthwise direction.

12. The liquid discharge apparatus according to claim 8, further comprising
a promoting member stacked on a lower surface of the first absorbent member, and configured to promote diffusion of the liquid in the first absorbent member.

13. The liquid discharge apparatus according to claim 12, further comprising
a waste liquid tank configured to store a waste liquid of the liquid,
wherein the promoting member includes a portion hanging down toward a flow passage communicating with the waste liquid tank.
